(19) United States
(12) Patent Application Publication
(10) Pub. No.: US 2009/0244808 A1
(43) Pub. Date: Oct. 1, 2009

(54) THIN-FILM CAPACITOR

(75) Inventors: Takashi OHTSUKA, Tokyo (JP); Nobuyuki OKUZAWA, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/410,825

(22) Filed: Mar. 25, 2009

(30) Foreign Application Priority Data
Mar. 31, 2008 (JP) 2008-091801

(51) Int. Cl. H01G 4/06

(52) U.S. Cl. 361/311

(57) ABSTRACT

An object of the present invention is to restrain warpage in a thin-film trench capacitor. A thin-film capacitor includes a substrate, a dielectric film, and a pair of electrodes, and the dielectric film is provided along a concave-convex surface on which are formed a plurality of convex portions extending away from the substrate. The concave-convex surface forms a pattern having one or more divisions arranged in a plane parallel to the main plane of the substrate, and the convex portions are arranged in either parts of the divisions or other parts. At least some of the divisions have parts extending along the x axial direction, and two or more of the extending parts overlap each other and terminate at locations that are different from each other, as viewed from the y axial direction orthogonal to the x axial direction.

### BACKGROUND OF THE INVENTION

1. Field of the Invention

The present invention relates to a thin-film capacitor.

2. Related Background Art

What are referred to as thin-film trench capacitors are conventionally known, wherein the electrode surface area is expanded by forming trenches in the substrate in order to make smaller, higher capacity thin-film capacitors (Japanese Patent Application Laid-Open No. 06-325970).

However, a problem with conventional thin-film trench capacitors is that they tend to warp when exposed to external heat. The problem of warping tends to become more obvious particularly when attempts are made to increase the trenches in order to achieve a high capacitance. Capacitor warpage results in various drawbacks such as variability in the properties of dielectric films, and there is thus strong demand to adequately restrain such warpage.

### SUMMARY OF THE INVENTION

An object of the present invention is therefore to restrain warpage in thin-film trench capacitors.

The present invention relates to a thin-film capacitor including a substrate, a dielectric film provided on one side of the substrate, and a pair of electrodes provided on either side of the dielectric film, wherein the dielectric film is provided along a concave-convex surface on which are formed a plurality of convex portions extending away from the substrate. The concave-convex surface forms a pattern having one or more divisions arranged in a plane parallel to the main plane of the substrate, and the convex portions are arranged in either parts of the divisions or other parts. At least some of the divisions have parts extending along a predetermined direction, and two or more of the extending parts overlap each other and terminate at locations that are different from each other, as viewed from a direction orthogonal to the predetermined direction.

When convex portions are arranged in the divisions, the locations of the ends of the convex portions are staggered, not aligned, in the direction orthogonal to the predetermined direction. In other words, in a projection of a division from the direction orthogonal to the predetermined direction, no parts other than the above division will remain in the projected image. When the locations of the ends of the convex portions are staggered in this manner, the trenches are formed along crooked lines between the convex portions. As the trench parts are relatively less rigid than the protrusion parts, when linearly linked trenches are formed, the lower thin-film capacitor rigidity in the direction orthogonal to the trenches in those parts will tend to result in warpage. However, the trenches are crooked, as noted above, so that there are fewer parts in which trenches are linearly formed, thus allowing warpage of the thin-film capacitor to be restrained. There are also fewer parts in which trenches are linearly formed when convex portions are arranged in parts other than the above divisions, thus similarly allowing warpage of the thin-film capacitor to be restrained.

The divisions having the extending parts will preferably include a division having a shape in which two or more strips orthogonal to each other are joined. This will allow warpage to be restrained even more effectively. When convex portions are formed in these divisions, the convex portions themselves will also be stably formed, and the convex portions will therefore sustain less damage during the step of forming convex portions or subsequent steps. This will allow thin-film capacitors to be produced with higher yields. Another advantage is that a high-density electrode surface area can be formed.

In the thin-film capacitor pertaining to the present invention, at least one protrusion is preferably arranged on any line within the main plane of the substrate. When only trenches are continuously formed on lines in the main plane of the substrate, the effect in restraining warpage in the direction orthogonal to the lines will be lower.

The thin-film capacitor of the present invention will allow the electrode surface area to be increased in order to achieve a high capacitance while adequately restraining warpage. Arranging convex portions or trenches in parts where divisions end in a predetermined direction will alleviate stress in that direction more than when convex portions or trenches are formed over the entire area in the predetermined direction. Alleviating stress will restrain current leakage caused by damage or the like to the dielectric film.

### BRIEF DESCRIPTION OF THE DRAWINGS

FIG. 1 is a perspective view showing an embodiment of a thin-film capacitor;

FIG. 2 is a plan showing an embodiment of a thin-film capacitor;

FIG. 3 is an end view along line III-III in FIG. 2;

FIG. 4 is a plan view showing an embodiment of a pattern of the concave-convex surface;

FIG. 5 is a plan view showing an embodiment of a pattern of the concave-convex surface;

FIG. 6 is a plan view showing an embodiment of a pattern of the concave-convex surface;

FIG. 7 is a plan view showing an embodiment of a pattern of the concave-convex surface;

FIG. 8 is a plan view showing an embodiment of a pattern of the concave-convex surface;

FIG. 9 is a plan view showing an embodiment of a pattern of the concave-convex surface;

FIG, 10 is a flow chart showing an embodiment of a method for producing a thin-film capacitor;

FIG. 11 is a flow chart showing an embodiment of a method for producing a thin-film capacitor;

FIG. 12 is a flow chart showing an embodiment of a method for producing a thin-film capacitor;

FIG. 13 is a flow chart showing an embodiment of a method for producing a thin-film capacitor;

FIG. 14 is an end view showing an embodiment of a thin-film capacitor;

FIG. 15 is a flow chart showing an embodiment of a method for producing a thin-film capacitor;

FIG. 16 is a flow chart showing an embodiment of a method for producing a thin-film capacitor;

FIG. 17 is a flow chart showing an embodiment of a method for producing a thin-film capacitor; and

FIG. 18 is a flow chart showing an embodiment of a method for producing a thin-film capacitor.

### DESCRIPTION OF THE PREFERRED EMBODIMENTS

Preferred embodiments of the present invention will be described in detail below with reference to the attached drawings as needed. However, the invention is not limited to the following embodiments. In the figures, identical or corresponding elements will be indicated by the same symbol. Elements that have already been described will not be described again where appropriate.

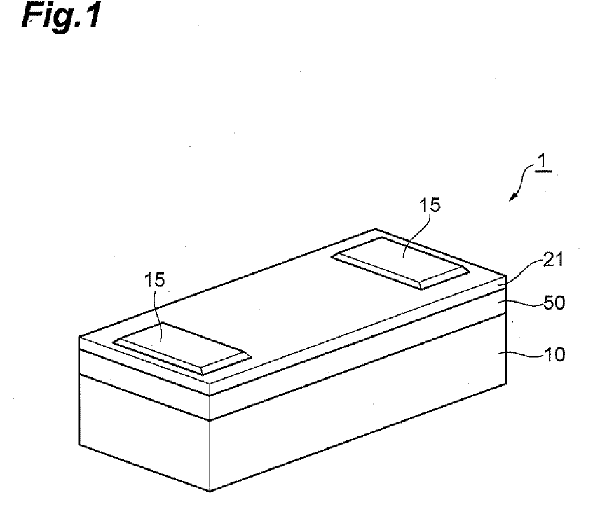

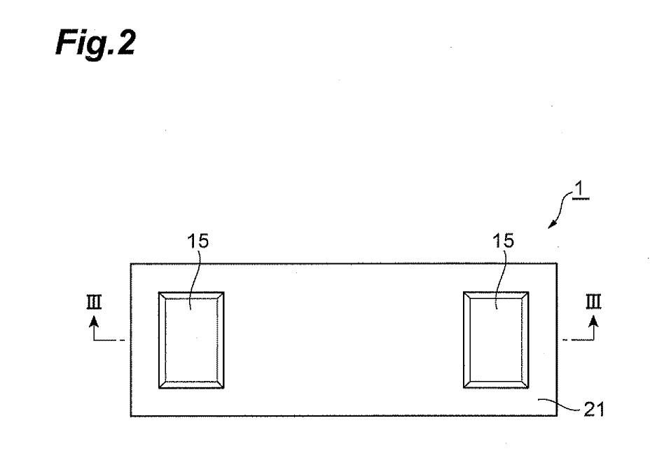

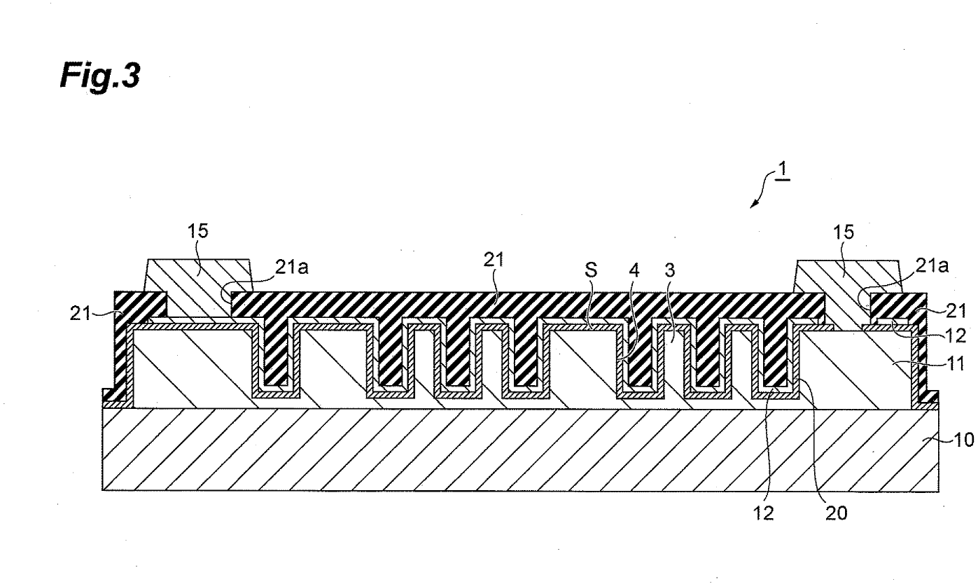

FIGS. 1 and 2 are a perspective view and plan view, respectively, showing an embodiment of a thin-film capacitor. FIG. 3 is an end view along line III-III in FIG. 2. The thin-film capacitor 1 shown in FIGS. 1 through 3 includes a substrate 10, a dielectric film 20 provided on one side of the substrate 10, a bottom electrode 11 and top electrode 12 provided on either side of the dielectric film 20, a protective film 21 that is provided on the top electrode 12 on the other side of the dielectric film 20 from the substrate 10 and that has two openings 21a formed therein through which a portion of the bottom electrode 11 or top electrode 12 is exposed, and two electrode pads 15 connected to the bottom electrode 11 or top electrode 12 in the respective openings 21a. The bottom electrode 11, dielectric film 20, and top electrode 12 are provided in a trench-forming layer 50 on the substrate 10.

The surface S on the dielectric film 20 side of the bottom electrode 11 is a concave-convex surface on which are formed a plurality of convex portions 3 extending in the direction away from the substrate 10. Trenches 4 are formed between adjacent convex portions 3. The dielectric film 20 on the bottom electrode 11 is provided along the concave-convex surface S.

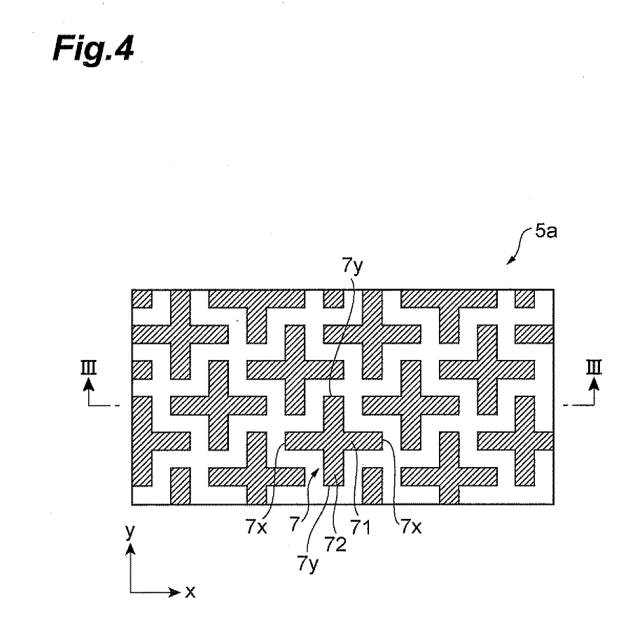

In the concave-convex surface S, there is formed a regular two-dimensional pattern having a plurality of divisions 7 arranged in a plane parallel to the main plane of the substrate 10. FIG. 4 is a plan view showing a pattern of the concave-convex surface S. Part of FIG. 3 corresponds to the end view along line III-III in FIG. 4. The pattern Sa shown in FIG. 4 has a plurality of divisions 7 regularly arranged apart from each other. The convex portions 3 are arranged in the division 7 parts.

The divisions 7 have first strips 71 extending along the x axial direction, which is the longitudinal direction of the substrate 10 and/or second strips 72 extending along the y axial direction orthogonal to the x axis. The divisions 7 having first strips 71 and second strips 72 have a shape in which the parts are joined while intersecting at right angles with each other at their respective centers. The divisions 7 having such a configuration can be referred to as cross-shaped.

In the pattern 5a, two or more first strips 71 overlap each other and terminate at locations that are different from each other, as viewed from the y axial direction orthogonal to the x axial direction in the pattern 5a. In other words, a plurality of divisions 7 having first strips 71 are arranged along the y axial direction while the locations, in the x axial direction, of the ends 7x where each terminates are staggered differently from each other. Two or more second strips 72 similarly overlap each other and terminate at locations that are different from each other, as viewed from the x axial direction. In other words, a plurality of divisions 7 having second strips 72 are arranged along the x axial direction while the locations, in the y axial direction, of the ends 7y where each terminates are staggered differently from each other. A plurality of divisions 7 are thus arranged differently from each other, so that trenches 4 in parts other than the divisions 7 are formed along crooked lines in most parts. This will result in more effective restraint of warpage.

In the pattern 5a, at least one division 7 is present on any line that is drawn in the main plane of the substrate 10. This corresponds to having at least one protrusion 10 on any line within the main plane of the substrate 10 in the thin-film capacitor 1.

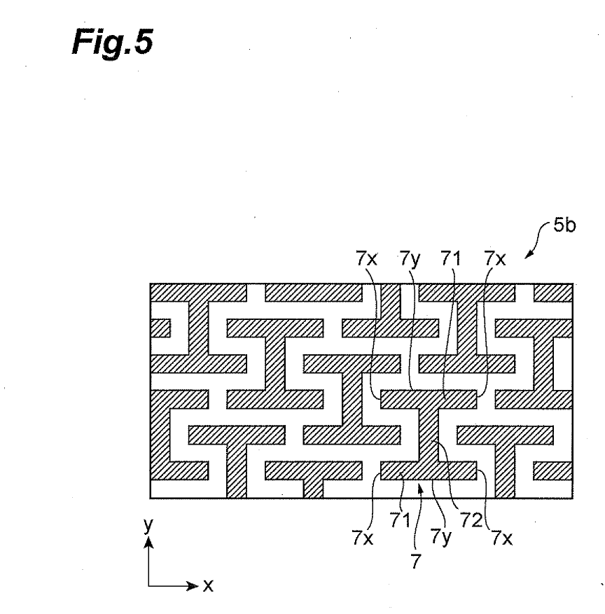

FIGS. 5, 6, 7, 8, and 9 are plan views showing other patterns of the concave-convex surface S.

The divisions 7 forming the pattern 5b shown in FIG. 5 also have first strips 71 extending along the x axial direction and/or second strips 72 extending along the y axial direction. The divisions 7 forming the pattern 5b have two first strips 71 and one second part 72, and include divisions having a shape in which the parts are joined while intersecting at right angles with each other in the center of the first strips 71. The divisions having such a configuration can be referred to as being H-shaped.

Two or more first strips 71 overlap each other and terminate at locations that are different from each other, when the pattern 5b is viewed from the y axial direction. In other words, a plurality of divisions 7 having first strips 71 are arranged along the y axial direction while the locations, in the x axial direction, of the ends 7x where each terminates are staggered differently from each other. Two or more second strips 72 similarly overlap each other and terminate at locations that are different from each other, when the pattern 5b is viewed from the x axial direction. In other words, a plurality of divisions 7 having second strips 72 are arranged along the x axial direction while the locations, in the y axial direction, of the ends 7y where each terminates are staggered differently from each other. The divisions are preferably arranged in such a way that, when two divisions adjacent to each other in this manner are selected, the first strips 71 of one division overlap the ends 7x of the other division, and even more preferably a plurality of divisions will be arranged in regularly alternating positions relative to each other

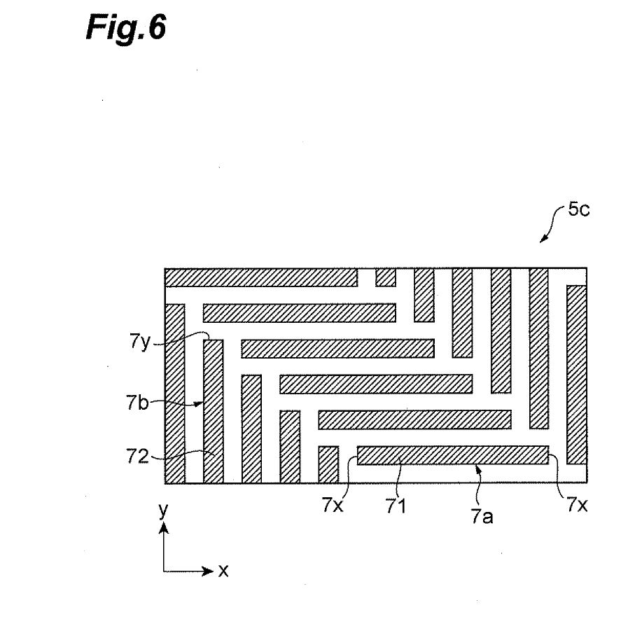

The pattern 5c shown in FIG. 6 is constituted by divisions 7a composed of first strips 71 extending along the x axial direction, and divisions 7b composed of second strips 72 extending along the y axial direction. The first strips 71 overlap each other and terminate at locations that are different from each other, when the pattern 5c is viewed from the y axial direction. In other words, a plurality of divisions 7a having first strips 71 are arranged while the locations of the ends 7x where each terminates are staggered in order in a constant direction. The second strips 72 overlap each other and terminate at locations that are different from each other, when the pattern 5c is viewed from the x axial direction. In other words, a plurality of divisions 7 having second strips 72 are arranged while the locations of the ends 7y where each terminates are staggered in order in a constant direction.

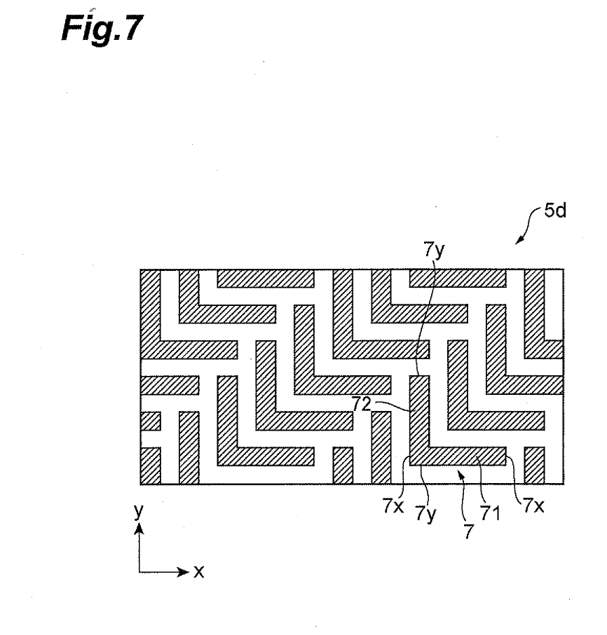

The divisions 7 forming the pattern 5d shown in FIG. 7 have first strips 71 extending along the x axial direction and/or second strips 72 extending along the y axial direction. The divisions 7 forming the pattern 5d have a first part 71 and a second part 72, and include divisions having a shape in which the parts are joined at one of their respective ends.

Two or more first strips 71 overlap each other and terminate at locations that are different from each other, when the pattern 5d is viewed from the y axial direction. In other words, a plurality of divisions 7 having first strips 71 are arranged while the locations of the ends 7x where each terminates are staggered in order in a constant direction. Two or more second strips 72 also overlap each other and terminate at locations that are different from each other, when the pattern 5d is viewed from the x axial direction. In other words, a plurality of divisions 7 having second strips 72 are arranged while the locations of the ends 7y where each terminates are staggered in order in a constant direction.

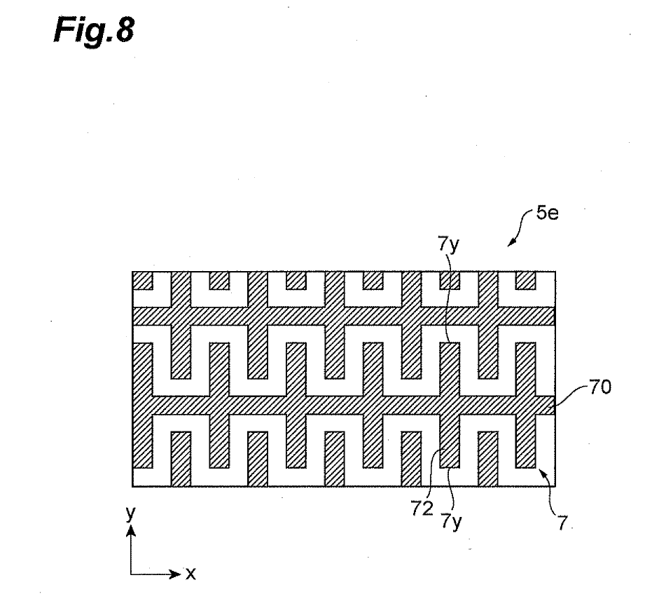

The divisions 7 forming the pattern 5e shown in FIG. 8 have strip-shaped non-terminating ends 70 extending over the entire range in the x axial direction, and a plurality of second strips 72 extending in the y axial direction, and include divisions having a shape in which the parts are joined while intersecting at right angles with each other in their respective centers. Two or more second strips 72 overlap each other and terminate at locations that are different from each other, when the pattern 5e is viewed from the x axial direction. In other words, two divisions 7 having second strips 72 are arranged in such a way that the locations of the ends 7y where each terminates are different from each other.

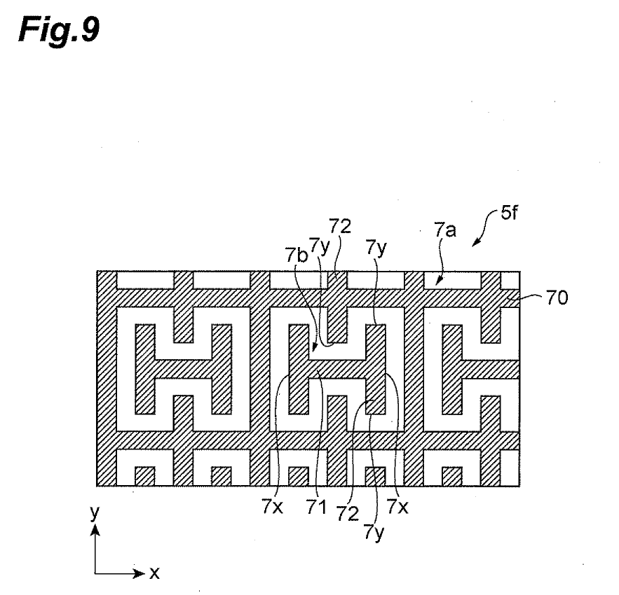

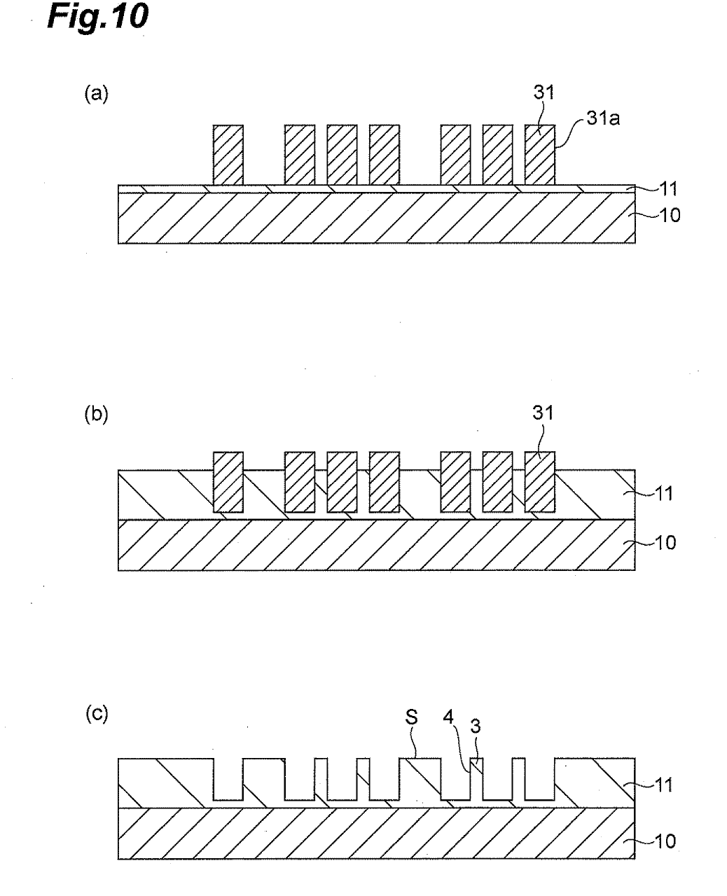

The pattern 5f shown in FIG. 9 is composed of divisions 7a that have a lattice-shaped non-terminating end 70 formed by a plurality of strips extending over the entire range in the x axial direction or y axial direction and second strips 72 extending along the y axial direction, as well as divisions 7b that have first strips 71 extending along the x axial direction and/or second strips 72 extending along the y axial direction. The divisions 7b are arranged in each area divided by the lattice-shaped non-terminating ends 70 of the divisions 7b. The divisions 7b have one first part 71 and two second strips 72, and include divisions having a shape in which the parts are joined while intersecting at right angles with each other in the center of the second strips 72.

The second strips 72 of the divisions 7a and the second strips 72 of the divisions 7b overlap each other and terminate at locations that are different from each other, when the pattern 5f is viewed from the x axial direction. In other words, two or more second strips 72 are arranged while the ends 7y where each terminates in the y axial direction are staggered differently from each other.

In thin-film capacitors on which the concave-convex surface has been formed with the patterns shown in the figures, parts with levels of stress that are different from each other, such as convex portions and trenches, are arranged on one side of the substrate. Warpage can be stopped by adopting an arrangement in which the protrusion or trench parts are not continuously linked on any line on the substrate surface. When such an arrangement is formed on part of the substrate surface, the effects of warpage may develop, but pairs of facing ends are more preferably not linearly joined in areas where convex portions or trench parts are formed. The pattern of the concave-convex surface will also preferably include cross-shaped divisions and/or H-shaped divisions. Convex portions having these shapes will have stronger resistance to stress and will afford good durability in particular.

The patterns on the concave-convex surface are not limited to the above embodiments and can be appropriately modified within the scope of the invention. For example, the shape of the portion extending in a predetermined direction in the divisions that form the pattern does not have to be strip shape, but may also be a shape such as a polygonal shape or an elliptical shape. In cases where the divisions extend along a curve, the extending parts may overlap each other and terminate at locations that are different form each other, viewing the pattern from the direction orthogonal to the tangent of the curve. Convex portions are also preferably arranged in parts of the divisions 7 in the interests of preventing warpage and alleviating stress, but convex portions may also be arranged in parts other than the divisions 7. In other words, trenches may be formed in parts of the divisions 7.

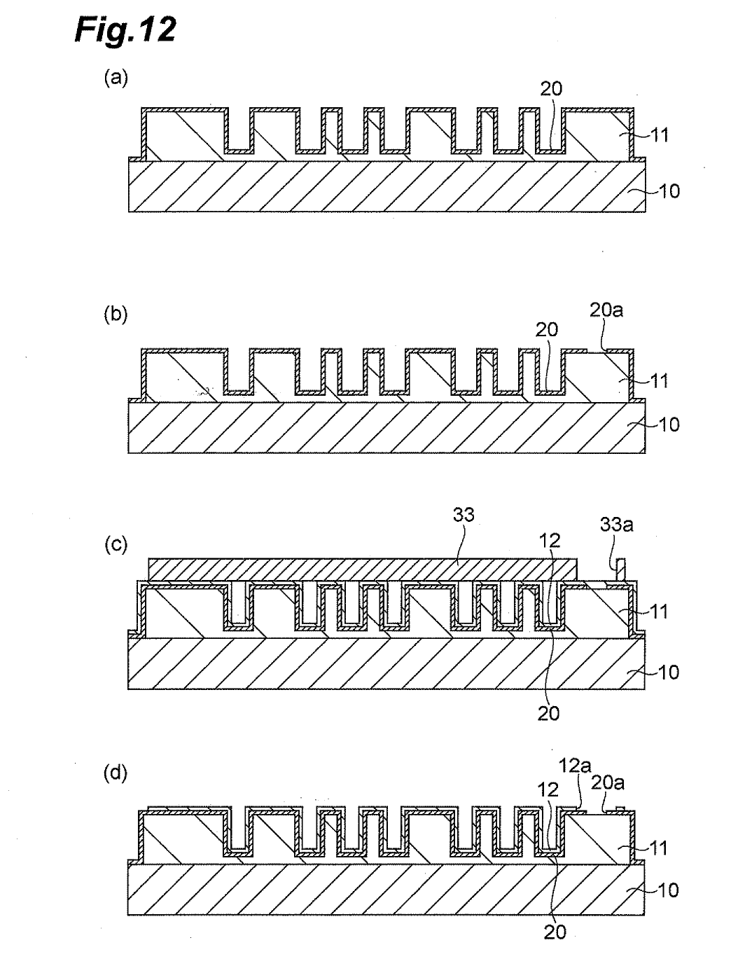

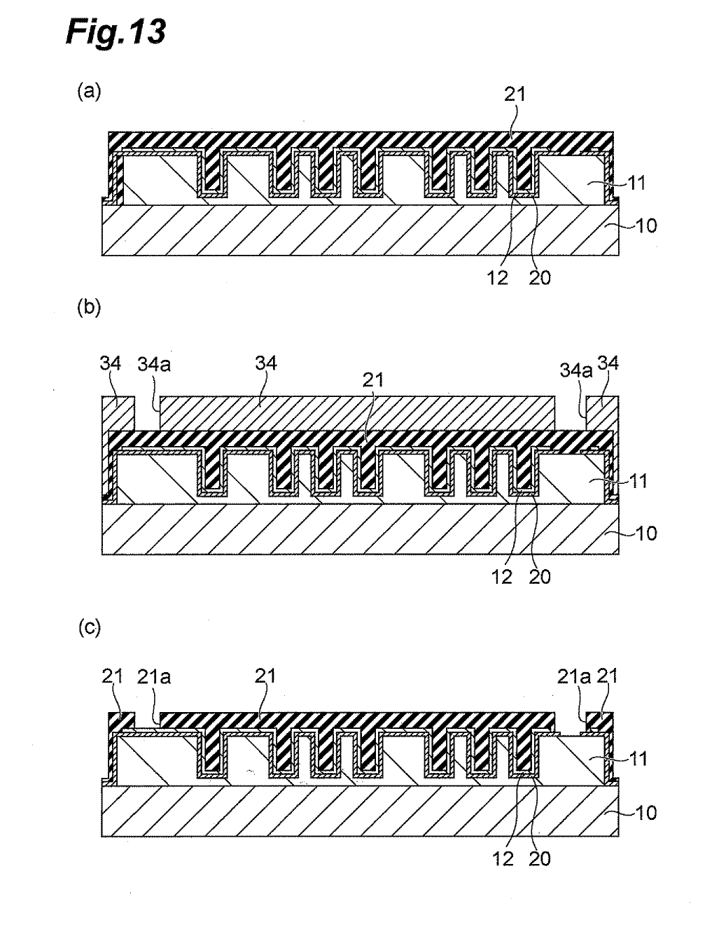

FIGS. 10, 11, 12, and 13 are flow charts in which embodiments of a method for producing the thin-film capacitor in FIG. 1 are shown by means of end views. The method pertaining to this embodiment includes a step (FIG. 10) of forming a metal layer 11 having a concave-convex surface S on a substrate 10, a step (FIG. 1) of removing some of the metal layer 11 on the substrate 10 and leaving a portion of the bottom electrode 11, a step (FIG. 12) of forming on the bottom electrode 11 a dielectric film 20 that is provided along the concave-convex surface S and that has an opening 20a through which a part of the bottom electrode 11 is exposed, a step (FIG. 12) of forming on the dielectric film 20 a top electrode 12 in which is formed an opening 12a through which the opening 20a is exposed, a step (FIG. 13) of forming on the top electrode 12 a protective layer 21 in which are formed openings 21a through which a portion of the bottom electrode 11 or top electrode 12 is exposed, and a step of forming electrode pads 15 that are connected to the bottom electrode 11 or top electrode 12 in the openings 21a.

A silicon substrate, alumina or other ceramic substrate, glass ceramic board, monocrystalline substrate of sapphire, MgO, SrTiO₃ or the like, or a metal substrate of Ti, Fe—Ni alloy, or the like may be used, for example, as the substrate 10. When a conductive substrate such as a metal substrate or silicon substrate is used as the substrate 10, an insulating film such as an oxide film is preferably formed on the surface.

The base of the metal layer 11 is formed on the substrate 10. Suitable examples of metals for forming the base of the metal layer 11 include Au, Pt, Ag, Sn, Cr, Co, Ni, Cu, and alloys containing them. Particularly when the base includes Ni as a main component, the film stress will be lower, resulting in even better effects in preventing warpage. The base can be formed, for example, by PVD such as sputtering, or CVD.

A resist layer 31 having a desired pattern is formed on the base of the metal layer 11 ((a) of FIG. 10). The resist layer 31 can be formed using a negative or positive photosensitive resin. The plated parts of the metal layer 11 are then formed inside the opening 31a of the resist layer 31 by means of plating ((b) of FIG. 10). Examples of metals for forming the plated portion may be selected from Au, Pt, Ag, Sn, Cr, Co, Ni, Cu, and alloys containing them, and different kinds than the metal of the base may be used. The use of Ni as main component of the base and Cu as the main component of the plated portion is particularly desirable. The resist layer 31 is removed to give a metal layer 11 having a concave-convex surface S composed of convex portions 3 and trenches 4 formed therebetween. The surface (main surface) of the metal layer 11 on the other side from the substrate 10 may be smoothed as needed by being polished using CMP or the like.

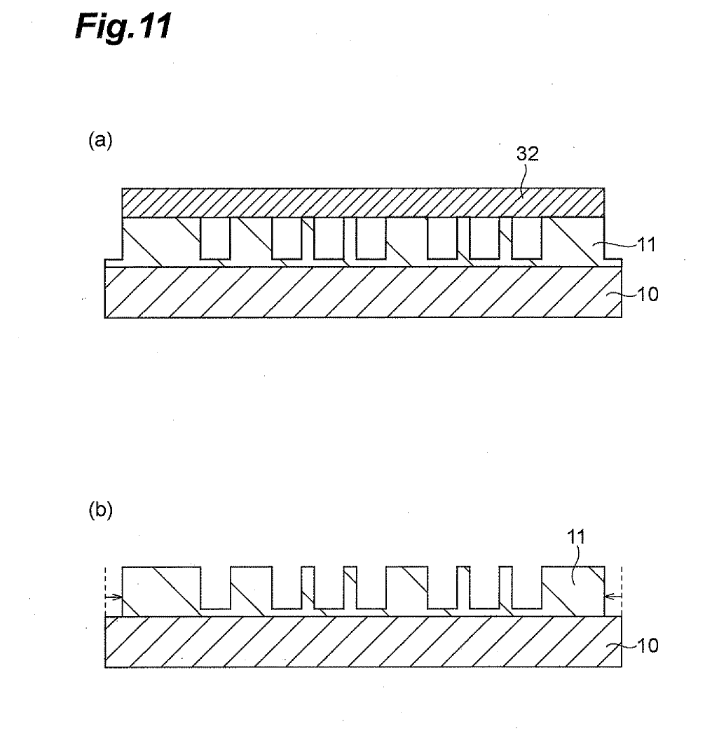

A resist layer 32 covering part of the metal layer 11 is formed ((a) of FIG. 11), and the resist layer 32 is used as a mask to remove part of the base of the metal layer 11. A bottom electrode 11 that is separate from the other adjacent metal layer portions (bottom electrode) is thus left over on the substrate 10. The metal layer 11 can be selectively removed by a common method such as wet etching. After the bottom electrode 11 has been formed, the resist layer 32 is removed ((b) of FIG. 11).

A dielectric film 20 covering the concave-convex surface S of the metal layer 11 is then formed ((a) of FIG. 12). Examples of preferred dielectric materials for forming the dielectric film 20 include Al₂O₃, SiN, PZT, and BaTiO₃. The dielectric film 20 can be formed by a method such as CVD or PVD. CVD is particularly desirable from the standpoint of making it easier to cover the concave-convex surface with a uniform thickness, etc. The resulting dielectric film 20 may be heat treated as needed to activate dielectric polarization. Part of the dielectric film 20 that has been formed is removed by photolithography to form an opening 20a through which the bottom electrode 11 is exposed ((b) of FIG. 12).

The entire surface of the dielectric film 20 on the other side from the bottom electrode 11 is covered, forming a film-shaped top electrode 12 that is connected to the bottom electrode 11 inside the opening 20a. On the top electrode 12 is formed a resist layer 33 in which is formed an opening 33a through which part of the top electrode 12 is exposed ((c) of FIG. 12). In this state, the top electrode 12 is selectively etched using the resist layer 33 as a mask, resulting in the formation of an opening 12a through which the opening 20a is exposed ((d) of FIG. 12).

An insulating protective layer 21 is then formed, covering the entire surface of the resulting laminate on the other side from the substrate 10 and filling the trenches 4 ((a) of FIG. 13). The protective layer 21 is formed with an inorganic material such as SiO₂ or Al₂O₃, or an organic material such as polyimide or epoxy resin.

On the protective layer 21 is formed a resist layer 34 in which is formed an opening 34a through which part of the protective film 21 is exposed ((b) of FIG. 13), and openings 21a through which the bottom electrode 11 or top electrode 12 is exposed are formed by removing parts of the protective film 21 using the resist layer 34 as a mask ((c) of FIG. 13). Electrode pads 15 are formed in the openings 21a, giving the thin-film capacitor 1 of FIG. 1. The electrode pads 15 are formed with Au, for example.

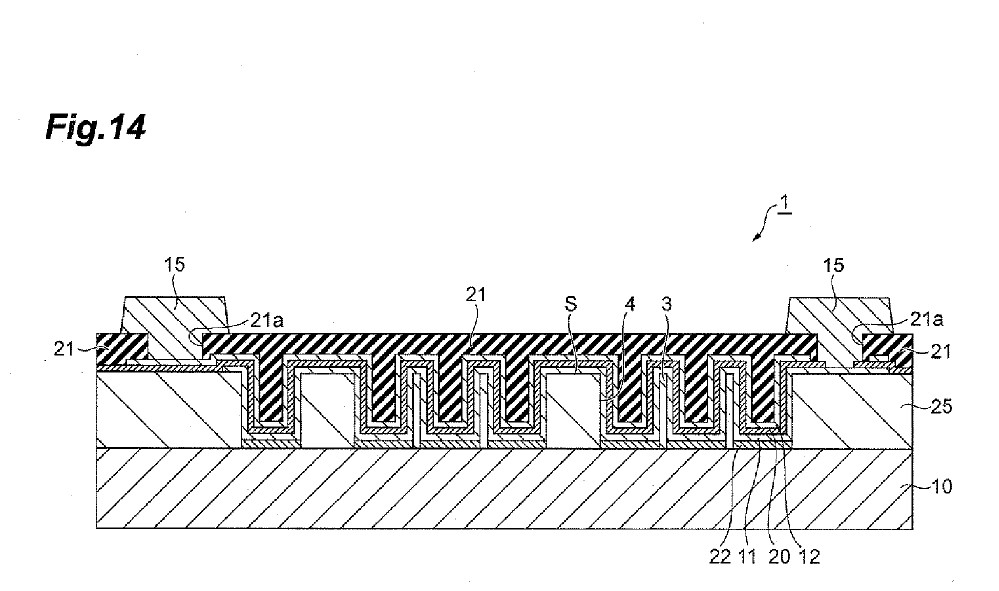

A dielectric film may be provided along a concave-convex surface that has been formed with another layer instead of the concave-convex surface formed with the bottom electrode as in the thin-film capacitor 1 of FIG. 1. The concave-convex surface may be formed primarily with an insulating layer, for example, as in the thin-film capacitor shown in FIG. 14.

The thin-film capacitor 1 shown in FIG. 14 is equipped with an insulating layer 25 provided on the substrate 10. The insulating layer 25 is patterned so as to form trenches 4 having the substrate 10 as its bottom surface. That is, the concave-convex surface S having convex portions 3 extending in the direction away from the substrate 10 is formed by means of the substrate 10 and insulating layer 25. An etching stopper layer 22 is provided on the bottom surface of the trenches 4. The bottom electrode 11, dielectric film 20, and top electrode 12 are laminated, in that order, along the concave-convex surface S. The structure is otherwise substantially the same as in FIG. 1.

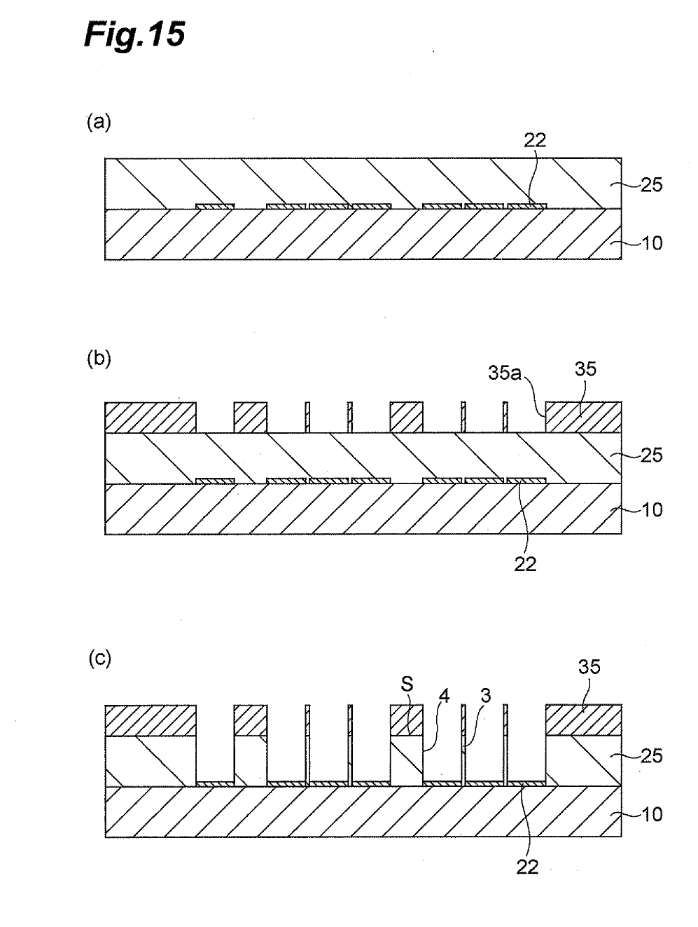

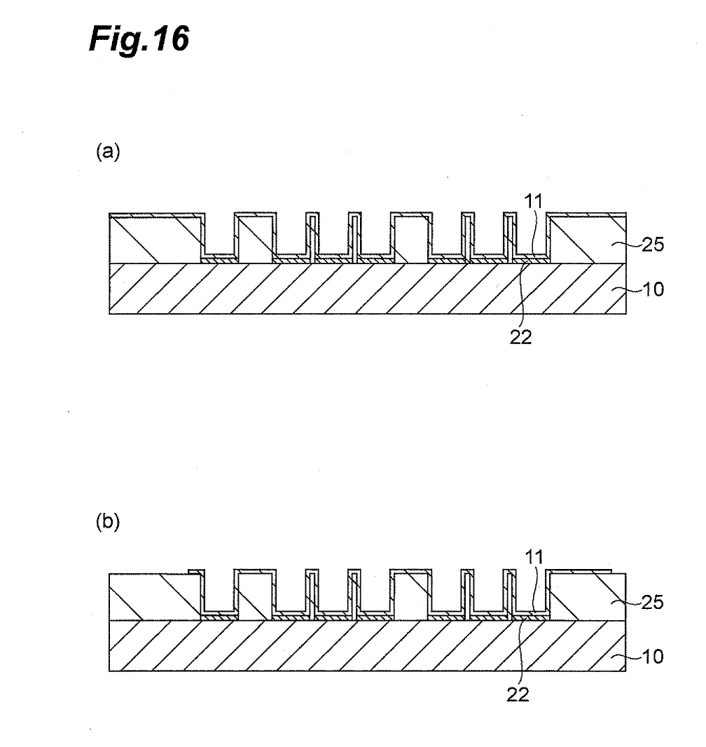

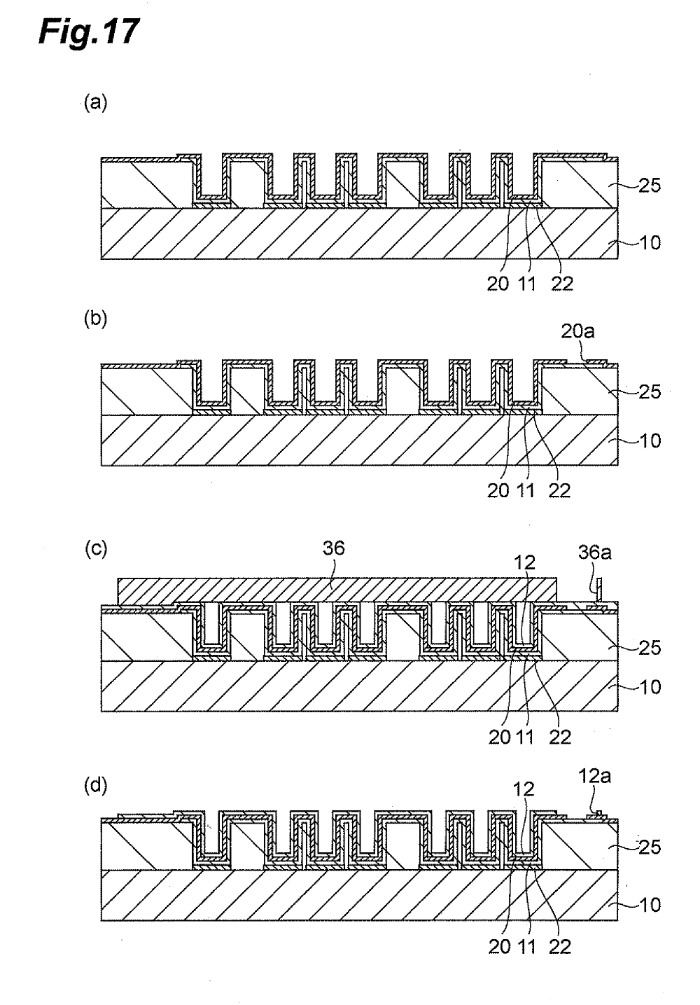

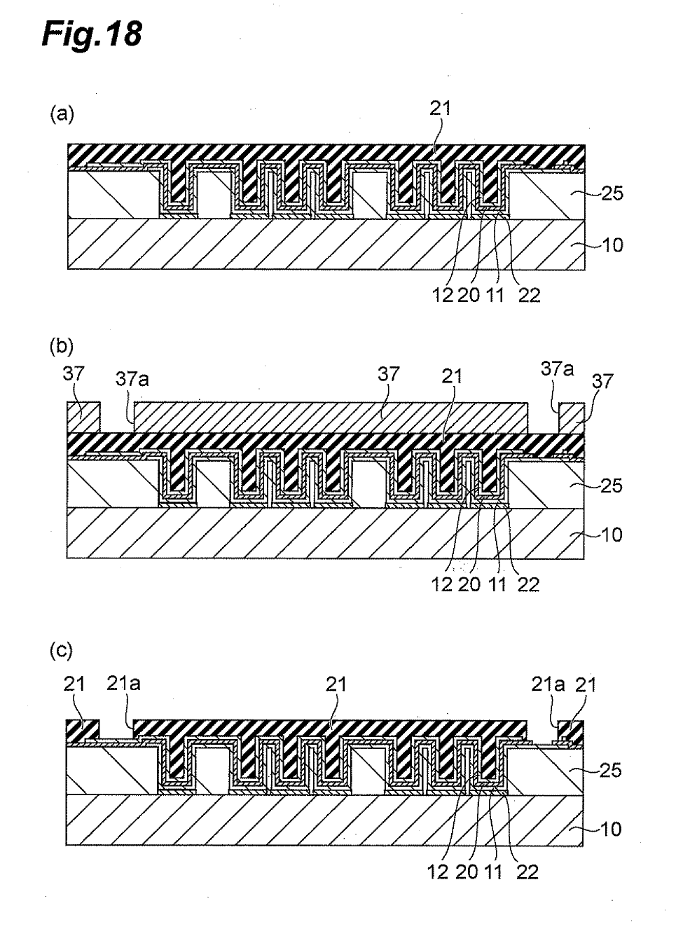

FIGS. 15, 16, 17, and 18 are flow charts in which embodiments of a method for producing the thin-film capacitor in FIG. 14 are shown by means of end views. The method pertaining to the embodiments in FIGS. 15 to 18 includes a step (FIG. 15) of forming, on a substrate 10, an insulating layer 25 patterned so as to form trenches 4 in which an etching stopper layer 22 is provided on a bottom surface which is the surface of the substrate 10, a step (FIG. 16) of forming, on the insulating layer 25 and the etching stopper layer 22, a film-shaped bottom electrode 11 that is provided along a concave-convex surface S formed by the substrate 10 and insulating layer 25, a step (FIG. 17) of forming on the bottom electrode 11 a dielectric film 20 that is provided along the concave-convex surface S and that has an opening 20a through which a part of the bottom electrode 11 is exposed, a step (FIG. 17) of forming on the dielectric film 20 a top electrode 12 in which is formed an opening 12a through which the opening 20a is exposed, a step (FIG. 18) of forming on the top electrode 12 a protective layer 21 in which are formed openings 21a through which the bottom electrode 11 or top electrode 12 is exposed, and a step of forming electrode pads 15 that are connected to the bottom electrode 11 or top electrode 12 in the openings 21a.

An etching stopper layer 22 is first formed at a location corresponding to the bottom of the trenches 4 on the substrate 10. The etching stopper layer 22 is formed with an insulating material such as Si₃N₄ or SiC. The etching stopper layer 22 can be patterned by a common photolithographic method.

An insulating layer 25 covering the substrate 10 and etching stopper layer 22 are then formed by a film-forming methods such as sputtering ((a) of FIG. 15). The insulating layer 25 is formed with an insulating material such as SiO₂ or Al₂O₃.

On the insulating layer 15 is formed a resist layer 35 in which is formed an opening 35a located at the top of the etching stopper layer 22 ((b) of FIG. 15). The insulating layer 25 is removed by etching using the resist layer 35 as a mask until the etching stopper layer 22 is exposed in the location of the opening 35a ((c) of FIG. 15). A concave-convex surface S having convex portions 3 is thus formed by the substrate 10 and insulating layer 25.

After the resist layer 35 on the insulating layer 25 has been removed, a film-shaped bottom electrode 11 is formed along the concave-convex surface S ((a) of FIG. 16). The film-shaped bottom electrode 11 is formed by CVD, for example. A portion of the bottom electrode 11 is removed by photolithography ((b) of FIG. 16).

A dielectric film 20 is formed by CVD on the entire surface of the resulting laminate on the other side from the substrate 10 ((a) of FIG. 17). Part of the dielectric film 20 that has been formed is removed to form an opening 20a through which part of the bottom electrode 11 is exposed. The thin-film capacitor 1 of FIG. 14 is then formed by the steps in FIG. 18 which are substantially the same as the steps in FIG. 13, etc.

What is claimed is:

1. A thin-film capacitor comprising a substrate, a dielectric film provided on one side of the substrate, and a pair of electrodes provided on either side of the dielectric film,
wherein the dielectric film is provided along a concave-convex surface on which are formed convex portions extending away from the substrate,
the concave-convex surface forms a pattern having one or more divisions arranged in a plane parallel to the main plane of the substrate, the convex portions being arranged in either parts of the divisions or other parts,
at least some of the divisions have parts extending along a predetermined direction, and
two or more of the extending parts overlap each other and terminate at locations that are different from each other, as viewed from a direction orthogonal to the predetermined direction.

2. The thin-film capacitor according to claim 1, wherein the divisions having the extending parts include a division having a shape in which two or more strips orthogonal to each other are joined.

3. The thin-film capacitor according to claim 1, wherein at least one protrusion is arranged on any line within the main plane of the substrate.
